(19) United States
(12) Patent Application Publication
(10) Pub. No.: US 2011/0192470 A1
(43) Pub. Date: Aug. 11, 2011

(54) SAFETY DEVICE FOR VENTILATING HEAT EMITTING LIGHT FITTINGS ANCILLARY EQUIPMENT AND WIRING

(76) Inventor: Richard Barry, Chepstow Place London (GB)

(21) Appl. No.: 12/593,505

(22) PCT Filed: Mar. 28, 2008
(86) PCT No.: PCT/AU2008/000447

§ 371 Date: Apr. 28, 2011

(30) Foreign Application Priority Data
Mar. 28, 2007 (AU) 2007901637

(51) Int. Cl. F16L 3/00; B23P 19/00

(52) U.S. Cl. 137/343; 29/428

(57) ABSTRACT

A device which enables a ventilation space to be maintained between an insulating material and an electrical appliance retained by a structure or located in a wall or ceiling space, the device comprising a body having at least one spacer extending therefrom, each spacer terminating in a free end, wherein when the device is placed between a layer of insulation material and the appliance, a ventilation space is formed which allows dissipation of heat generated by the appliance.

### RELATED APPLICATIONS

This application claims foreign priority benefits under 35 U.S.C. §119(a)-(d) or 35 U.S.C. §365(b) of Australia application number 2007901637, filed 28 Mar. 2007.

### BACKGROUND OF INVENTION

1. Field of Invention

The present invention relates to electrical safety and more particularly relates to a device which improves ventilation around light fittings, ancillary equipment and wiring, particularly those mounted in confined spaces which emanate heat.

2. Discussion of Related Art

There are in existence a wide variety of light fittings used in domestic and industrial applications most of which consume power which generates heat in the production of light. Light fittings which produce heat can be dangerous, creating a potential fire hazard if heat is unable to escape from the high heat zone about heat generating parts of a light fitting.

Light fittings are commonly mounted in ceiling cladding so that the light emitting part projects in the direction of a room space to be lit and the electrical connection assembly projects into the ceiling space. Halogen lights emit high levels of heat from both the light bulb and associated ancillary equipment like the transformer. The transformer is usually mounted in a ceiling space adjacent the light fitting. In use, the transformer and light fitting become quite hot in a ceiling space which itself can be hot enough to reach up to and beyond 60 degrees centigrade. Since considerable heat is generated by the transformer, it is important that it is located in an area that allows adequate heat dissipation by ventilation. Ceiling spaces usually accommodate some form of insulation. This may take the form of separate elements generically known as batts or sprayed insulation. In both cases light fittings are usually covered trapping heat and creating a potential fire hazard. Currently no satisfactory device exists which ensures that there remains an adequate ventilation space between the insulation and heat emitting parts of a light fitting such as a the halogen light, the• transformer, ancillary equipment and electrical wiring to minimise or eliminate fire risk.

Downlight halogen lights which give even, gentle, low shadow lighting within a room when mounted into the ceiling, are becoming increasingly popular for lighting living areas, kitchens and bathrooms. One advantage of halogen down lights is that they are more efficient than more traditional incandescent bulbs (i.e. conventional bulbs), using only half the energy to produce the same light output and last twice as long. Generally, halogens are lights which generate a lot of heat so they can only be used in light fittings designed to cope with the higher temperatures. There are two main types of halogen lights available which include those using low voltage and which require a transformer to lower the voltage of the standard household and commercial electricity supply to levels required by these lights. Typically, the transformers used with low voltage lighting convert the voltage of the electricity supply from 240 volts to 12 volts.

A transformer has to be fitted either with the light fitting itself or remotely. The advantages of the lower power are that the safer voltage enables manufacturers to produce interesting and slim designs without the need to protect against danger from higher voltages. Transformers can be either electronic or ‘wire wound’. The newer electronic transformers are more energy efficient and smaller but more expensive than the conventional wire wound type. The low voltage light fixtures and transformer units generate thermal heat. If this thermal heat builds up in and around the transformer unit, it can cause the transformer unit temperature to rise above a predetermined safety level, and as a consequence the transformer unit will shut down resulting in the halogen light turning off. Insulation material (for heat, noise etc insulation) used in roof ceilings (and other areas like between floors and walls) compound the build up of thermal heat in and around the transformer unit, the low voltage light fitting, ancillary equipment and electrical wiring. This increases potential fire risks and the likelihood of the temperature of the transformer unit rising above the predetermined safety level and thus turning off. Currently, there is no practical solution in the market place to alleviate this build up of thermal heat in and around the transformer unit, the low voltage light fixtures, ancillary equipment and electrical wiring due to the insulation materials.

There is a long felt want in the industry to provide a convenient solution to the significant problem of heat build up in ceiling spaces from light fittings, transformer units, ancillary equipment and electrical wiring—particularly heat build up caused by the capacity of insulation to trap heat near the fittings and to reduce or eliminate the fire risk and/or damage to light fittings, ancillary equipment and wiring. Furthermore, it is important to maintain an uninterrupted coverage of insulation material (i.e. no holes or gaps in the insulation material), as studies have found that if 5% of a ceiling area is not covered by insulation material, it can result in a loss of up to 50% of the potential insulation benefits. Finally, noise standards can be maintain in regards to noise insulation materials since no gaps are created between the noise insulation materials.

### SUMMARY OF INVENTION

The present invention seeks to provide a solution to the prior art problem of unwanted heat build up near light fittings in a ceiling space.

In accordance with this objective the present invention provides a device which improves ventilation around light fittings, ancillary equipment and wiring (we will refer to these together below as the light fitting) particularly those mounted in a confined space which emanate heat. The invention also provides a safety device and assembly for retaining a ventilation space around a light fitting mounted to a structure and particularly in ceilings to allow heat dissipation from such fittings. The device and assembly in all its forms to be described below provides separation of insulating material from contact with components of a light fitting, particularly those components emitting heat. In accordance with a method aspect, the invention further comprises a method for separating insulation from light fitting using a spacing assembly which includes a device which maintains a void between insulation and the components of a light fitting.

Although the invention will be described primarily with reference to its application to light fittings and particularly light fittings it will be appreciated by persons skilled in the art that the invention has applications in other areas in which a void space must be maintained around heating emitting fittings.

In its broadest form the present invention comprises: a device which enables a ventilation space to be maintained between an insulating material and an electrical appliance retained by a structure, the device comprising a body having at least one spacer extending therefrom, each terminating in a free end: wherein, when the device is placed between a layer of insulation material and the appliance the ventilation space is formed which allows dissipation of heat generated by the appliance.

Preferably the device comprising a spine from which extends said at least one spacer; wherein, the spine provides a bearing surface which engages either a surface of the insulation or a surface of the structure depending upon the orientation of the device. Each spacer has a first end which engages the spine and a second end which terminates in a bearing surface. The spine forms an annular collar from which depend a plurality of evenly spaced spacers. The spacers comprise legs each terminating in a foot which includes the bearing surface. The legs are ideally spaced apart at 120 degree spacing therebetween. The collar includes a frangible bridge to enable displacement of the collar so that the circumference of the collar can be reduced. The frangible bridge may comprise perforations in the collar which enable the collar to be cut allowing opposing ends of the circumference to be drawn together or to overlap so as to reduce the diametric size of the collar to enable it to be fitted through a ceiling opening. Reduction of the circumferential length of the collar allows insertion of the device through a variety of openings in a ceiling which are smaller than a maximum outside diameter of the collar. The spacer legs and collar are integrally connected wherein the feet each include engaging teeth on their bearing surface. The structure in which the light fitting is placed is according to one embodiment a ceiling such that the part of the light extends into a ceiling space and a light emitting part extends inside a room space. The device supports an insulating element thereby keeping the insulating element separated from the appliance to enable dissipation of heat generated by the appliance. The appliance is preferably a light fitting or power supply cable. According to a preferred embodiment the device is manufactured from a plastics or suitable insulting material and in the case of a plastics material preferably formed in a mould. The device may be used in two orientations. In the first the collar is uppermost and in the second the device is inverted so that the collar engages the ceiling material and the feet of the spaced part legs form insulation support to keep that insulation spaced away from the appliance. The collar provides a support base allowing elevation of the feet above the collar when the device sits in an inverted position. The collar may include a flange which locates the device in an opening in which a light fitting is be inserted. The device may also be detachably attached to a light fitting.

In another broad form the invention comprises: a device for providing a space between an insulating material and a light fitting supported by a structure, the device comprising a body having at least one strut extending therefrom and terminating in a free end: wherein when the device is placed adjacent a light fitting (or attached to or incorporated on the light fitting) the separation space so formed isolates said insulating material from said light fitting.

Preferably the device is free standing and is placed above the light fitting in a ceiling space. However, it could also be attached to or incorporate on the light fitting. The structure in which the light fitting is placed is preferably a ceiling cladding such that the part of the light extends into the ceiling space and part—i.e. the light emitting part extends into a room space. The separation space created by the device receives and supports an insulating element thereby keeping the insulating element separated from the light fitting to enable dissipation of heat generated by the light fitting.

In another broad form the present invention comprises: an assembly for providing a space between an insulating material and a light fitting supported by a structure, the assembly comprising a body having at least one strut extending therefrom and terminating in a free end, the at least one strut extending from said body and forming a space frame which is placed over a light fitting to maintain separation between an insulating material and the light fitting, wherein the separation space so formed isolates said insulating material from said light fitting and allows ventilation thereabout.

According to one embodiment, there is provided a spacing device comprising a generally circular collar including a flange which locates the device in an opening in which a light fitting may be inserted. Extending from the collar are a plurality of legs which are spaced about the collar defining a space internal of the legs. The spacing device may be used by engaging the collar with the ceiling and allowing the legs to extend upwards. In another embodiment the collar may be inverted so that the legs are placed on a ceiling surface and the collar provides a support for insulation, keeping the insulation separate from the light fitting. In another embodiment, two of said devices may be connected to increase the size of the void space.

In a further embodiment, the device is formed by a plurality of legs which terminate at one end in a free end foot and at an opposite end each leg terminates in and is integral with a platform. This spacing device may be used alone or a second like device may be piggy backed into the first device. Each leg preferably terminates in a foot which acts either as a ground engaging foot or collectively with feet from the other legs as a support for an insulation batt.

In another embodiment an assembly is formed from two of the devices such that one is feet down and the other joined to the first of the two is feet up so that one is essentially a mirror image of the other.

In one embodiment, a plurality of the devices may be integrated to provide an assembly allowing homeowners to fit the devices under insulation.

It is one objective of the present invention to reduce the risk of fire and overheating of light fittings in ceilings. It is another objective of the invention to provide a removable device or assembly of integrated devices which is easily fitted (from either under the ceiling via the light hole or above the ceiling) adjacent or over light fittings to create a ventilation void. A further objective is to maintain an uninterrupted coverage of insulation material (i.e. no holes or gaps in the insulation material) whilst creating the ventilation void.

Finally, with one of the embodiments, where the spacing device has the engaging the collar with the ceiling and allowing the legs to extend upwards, the collar also protects the ceiling hole cut out area (of multiple sizes) from potential damage when halogen downlights are removed and allows for the easy rotation for re-aiming of gimble halogen downlights. The size of the collar on one embodiment can be changed via a perforated joint on the collar in order for it to fit in a range of different ceiling hole cut out sizes. A detachable collar on the underside of the ceiling will help hold the inverted device firmly in position within the ceiling hole.

According to a method aspect the present invention comprises: a method of protecting a heat emitting appliance in a wall or ceiling space using a device which enables a ventilation space to be maintained between an insulating material and the appliance; the device comprising a body having at least one spacer extending therefrom, each terminating in a free end; the method comprising the steps of: a) taking the device and placing it through an opening in a ceiling of a structure so that the device locates on a surface of the ceiling in a roof space; b) placing the device between a layer of insulation material and the appliance to form a ventilation space which allows dissipation of heat generated by the appliance; c) placing a plurality of like devices between the insulation and the appliance to create a ventilation space at the locations of each device.

### BRIEF DESCRIPTION OF DRAWINGS

The invention will now be described in more detail according to a preferred but non limiting embodiment and with reference to the accompanying illustrations wherein:

FIG. 1 shows a perspective view of a spacing device according to a preferred embodiment with a plurality of legs each with a free end foot.

FIG. 2 shows the device of FIG. 1 disposed in an inverted manner in a ceiling.

FIG. 3 shows a perspective view of two devices similar to the type described in FIG. 1 but with four legs joined in mirror image to provide double the separation space.

FIG. 4 shows an enlarged view of the means of engagement between opposing feet of the two devices shown in FIG. 3.

FIG. 5 shows a perspective view of a spacing device according to an alternative embodiment.

FIG. 6 shows a top view of the device of FIG. 5.

FIG. 7 shows an elevation view of the device of FIG. 5.

FIG. 8 shows an enlarged perspective view of a spacing device according to a preferred embodiment.

FIG. 9 shows a cross sectional view of a ceiling and joist construction with insulation laid over a halogen light and transformer.

FIG. 10 shows a cross sectional view of a ceiling and joist construction with insulation separated by a pair of inverted spacers laid adjacent a halogen light and transformer.

FIG. 11 shows a cross sectional view of a ceiling and joist construction with insulation separated by a spacer laid over a halogen light and transformer.

FIG. 12 shows how the insulation surrounds and encases both the transformer unit, the light fitting and electrical wiring.

FIG. 13 shows a perspective view of a spacing device according to an alternative embodiment.

FIG. 14 shows a series of ventilation devices located under insulation.

FIG. 15 shows a plan view of the arrangement of FIG. 14.

FIG. 16 shows an enlarged perspective view of a spacing device indicating scissor cutting of a frangible section.

FIG. 17 shows an example of insertion of the spacing device of FIG. 16 displaced after cutting and manually urged through a ceiling.

FIG. 18 shows illustratively how the sagging tendency or overhanging of the soft insulation materials is reduced by the use of device.

FIG. 19 shows an arrangement of stacked spacing devices.

FIG. 20 shows an example of a ventilation device on an inclined ceiling.

FIG. 21 shows a soft insulation material with a transformer unit sinking into the insulation material.

FIG. 22 shows transformer unit fixed to a platform of a spacing device which may then be placed directly on top of insulation material.

FIG. 23 shows one embodiment of the device inverted in a ceiling with a halogen down light inserted in position.

FIG. 24 shows a perspective view of a spacing device according to an alternative embodiment in a contracted form.

FIG. 25 shows a perspective view of the device of FIG. 24 unfurled.

FIG. 26 shows an end perspective view of the device of FIG. 23 in a configuration allowing insertion through a ceiling opening.

FIG. 27 shows a sectional elevation through a ceiling space with opposing devices of the type shown in FIG. 24.

FIG. 28 shows an inverted view of a separation device with split collar according to an alternative embodiment.

FIG. 29 shows an inverted view of a separation device with split collar according to an alternative embodiment including engaging tabs.

FIG. 30 shows an opposite perspective view of the separation device of FIG. 28.

FIG. 31 shows an inverted view of the separation device of FIG. 29 with split collar engaging tabs.

FIG. 32a shows with corresponding numbering a cross sectional view of the separating device of FIG. 29 installed in a ceiling.

FIG. 32b shows an abbreviated enlarged view of the device of FIG. 32a showing a gap in the collar and perforations.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

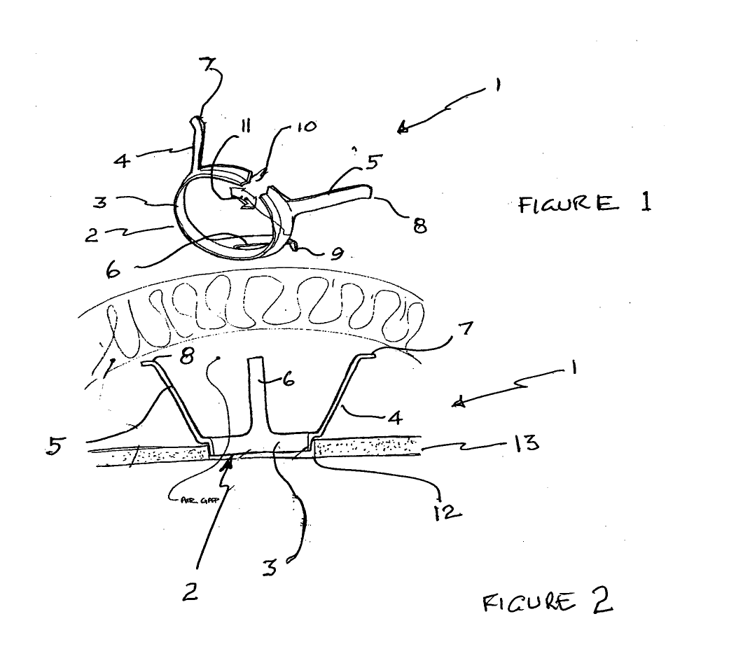

FIG. 1 shows a perspective view of a spacing device 1 according to a preferred embodiment. Device 1 comprises a collar 2 having a flange 3 which is adapted to engage a rim of an opening in which a light fitting is placed. Extending from collar 2 are a plurality of legs 4, 5, 6 each terminating in respective free end feet 7, 8 and 9. Preferably, the legs are splayed and device 1 may be disposed in a first upright orientation or alternatively in a second inverted orientation. FIG. 1 shows the device 1 disposed in an inverted orientation. According to the embodiment shown, collar 2 further comprises an abbreviation 10 which allows circumferential movement of collar 2 in the direction of arrow 11. Abbreviation 10 allows the diameter of collar 2 to be adjusted by adjusting the circumferential length within a range commensurate with the abbreviation. This allows the elastic memory of the device to engage a ceiling by positive friction fit allowing it to resist movement. It also allows device 1 to be inserted via the light hole from below the ceiling. Furthermore, a perforated joint in collar 2 can reduce the size of the circumference by detaching part of collar 2 along the perforation joint (for example, if the circumference of the collar is 90 mm, a section of collar 2 can be removed at the perforation joint in order to make a 70 mm circumference)—see FIGS. 29-32 for more detailed description of this embodiment).

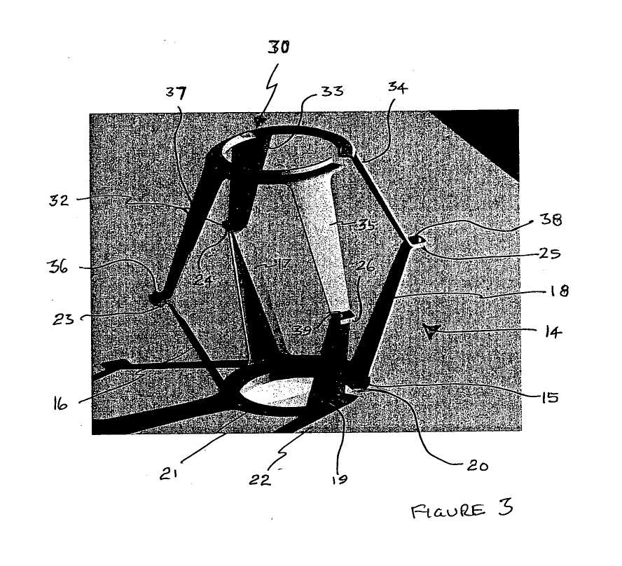

FIG. 2 shows the device 1 of FIG. 1 with corresponding numbering disposed in an opening 12 in a ceiling cladding 13. Device 1 separates ceiling 13 from insulation layer 27 creating an air gap therebetween.

FIG. 3 shows a perspective view of a device 14 in inverted orientation with a like device 30 disposed in an opposing mirror image orientation so that the two devices provide double the separation space. Device 14 comprises a collar 15 having an abbreviation 20 flange 21 which engages cladding 22.

Extending from collar 15 are four legs 16, 17, 18 and 19 each terminating in respective free end feet 23, 24, 25 and 26. Preferably, the legs are splayed and device 14 is disposed so that opposing feet on devices 30 mutually engage. Device 30 comprises collar 31 and downwardly depending therefrom legs 32, 33, 34 and 35 terminating in respective feet 36, 37, 38 and 39. Thus foot 23 of device 14 engages with opposing foot 36 of device 30 and likewise foot 24 with opposing foot 37, foot 25 with foot 38 and foot 26 with foot 39. Each said feet inter engage via interfitting of corresponding male and female profile parts.

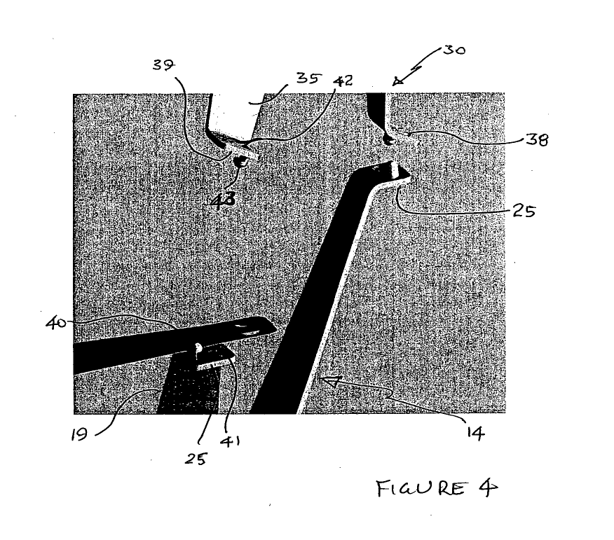

FIG. 4 shows an enlarged exploded view of the means of engagement between opposing feet of the two devices shown in FIG. 3. The example shows feet 39 and 25 and 38 and 25 separated to reveal opposing respective male and female profile parts. Thus foot 25 has a male part 40 and an adjacent opening 41. Foot 39 which opposes foot 25 has an opening 42 which receives and retains male part 40 and a male part 43 which is received and retained by opening 44 in foot 25.

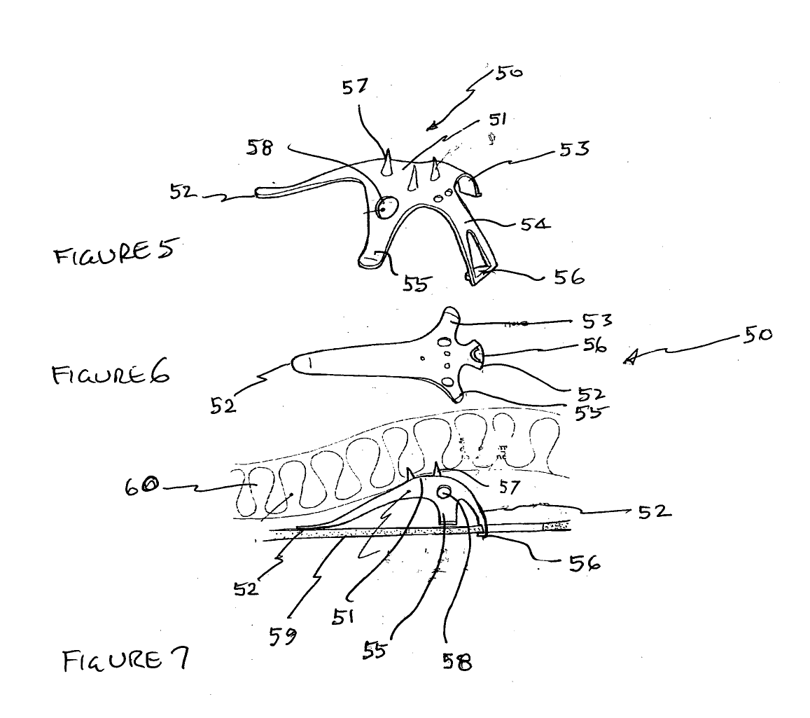

FIG. 5 shows a perspective view of a spacing device 50 according to an alternative embodiment. Device 50 comprises a platform 51 from which extends legs 52, 53, 54 and 55. Leg 54 includes a tab 56 which functions to engage a structure to which the device 50 is attached. In this embodiment, spikes 57 are disposed on platform 51 which assist in the retention of insulation 60 laid over platform when device 50 is in use. Device 50 further includes openings 58 which assist ventilation.

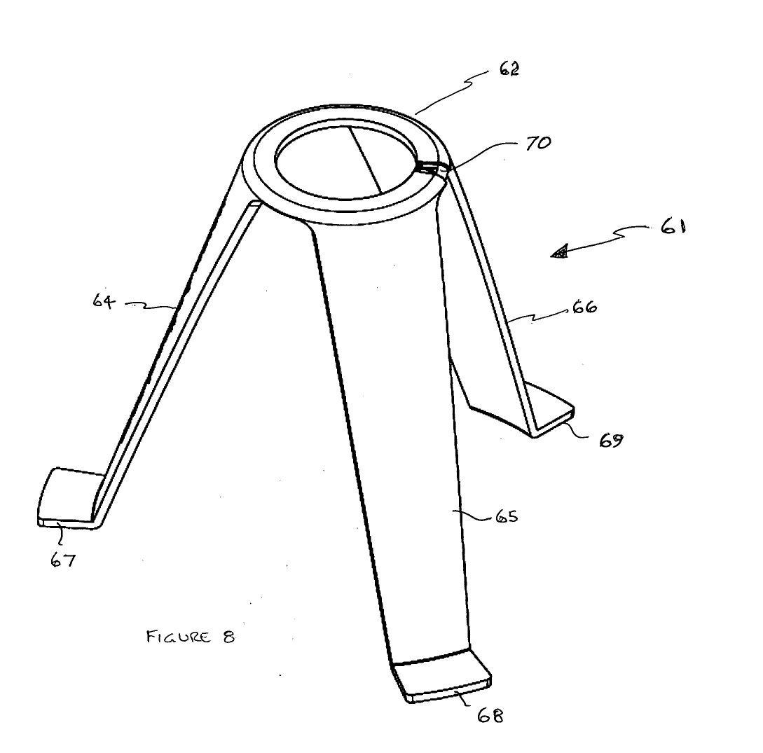

FIG. 6 shows a top view of the device 50 of FIG. 5 with corresponding numbering and FIG. 7 shows an elevation view of the device 50 of FIG. 5 engaging ceiling cladding 59 via tab 56 and supporting insulation layer 60. As may be seen from the side elevation tab 56 retains device 50 in position to resist displacement.

In use a halogen light transformer may be fitted remotely from a light fixture; or fitted within the light fixture itself. The majority of low voltage halogen down lights installed in ceilings are recessed halogens (i.e. lights sitting flat and flush with the ceiling) and have the transformer fitted remotely from the actual light fixture itself.

FIG. 8 shows an enlarged perspective view of a spacing device 61 according to a preferred embodiment. Device 61 comprises a collar 62. Extending from collar 62 are a plurality of legs 64, 65, 66 each terminating in respective free end feet 67, 68 and 69. Preferably, the legs are splayed and device 61 may be disposed in a first upright orientation or alternatively in a second inverted orientation. Collar 62 further comprises an abbreviation 70 which allows circumferential movement of collar 62. Abbreviation 70 allows the diameter of collar 62 to be adjusted by adjusting the circumferential length within a range commensurate with the circumferential length of the abbreviation. This allows the elastic memory of the device to engage a ceiling by positive friction fit allowing it to resist movement. It also allows device 61 to be inserted via a hole from below the ceiling. Furthermore, a perforated joint in collar 62 can reduce the size of the circumference by detaching part of collar 62 along the perforation joint (for example, if the circumference of the collar is 90 mm, a section of collar 62 can be removed at the perforation joint in order to make a 70 mm circumference).

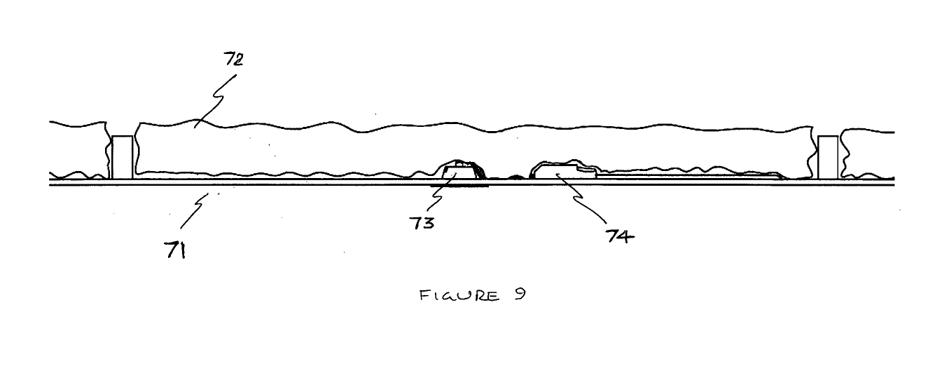

FIG. 9 shows a cross sectional view of a ceiling and joist construction 71 with insulation 72 laid over a halogen light 73 and transformer 74. This is an example of an unwanted configuration where insulation layer envelops light 73 and transformer 74. This can generated unwanted heat which cannot escape leading to risk of overheating and possibly fire.

FIG. 10 shows a cross sectional view of a ceiling and joist construction 75 with insulation 76 separated by a pair of inverted spacers 77 and 78 laid adjacent a halogen light 79 and transformer 80.

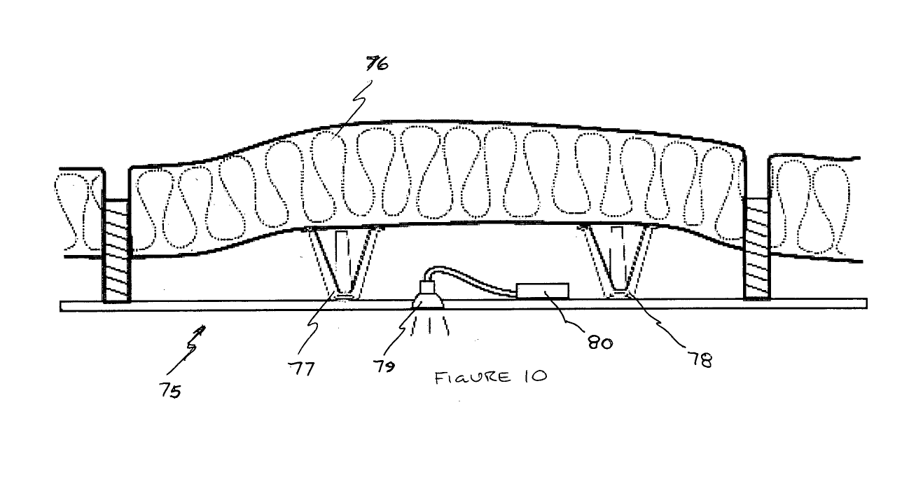

FIG. 11 shows a cross sectional view of a ceiling and joist construction 81 with insulation 82 separated by a spacer 83 laid over a halogen light 84 and transformer 85.

Where there are insulation materials in the ceiling, Australian Standards require clearance of at least 25 mm must be maintained between the halogen downlight fixture and the other ancillary equipment like a transformer and the insulation materials—see: AS/NSZ 3000:2000 (for electrical contractors) and AS 3999:1992 (for insulation installers). Similar requirements apply in other jurisdictions around the world. This 25 mm clearance between the insulation material and the halogen down light and ancillary equipment like the transformer is to allow free air flow in order to minimise the chances of operation failure by the transformer, the luminare overlamping, reduces or eliminates the fire risk and/or damage to light fittings, ancillary equipment and wiring.

By the nature of their operation, transformer units emit thermal heat during the process of converting one voltage to another. This combined with the fact that transformer units are usually encased in non-conducting material often results in build up of heat in the unit housing the transformer unit. The transformer unit is designed to allow the build up of this internal heat within the transformer unit (the “internal heat”) to dissipate from within the transformer unit via vents.

In the event that the internal heat cannot be dissipated from a transformer unit and a predetermined heat level within the transformer unit is reached, then a safety mechanism will switch the transformer off until the temperature of the transformer unit is reduced below the predetermined safety level (the “Internal Heat Shut Down”). This Internal Heat Shut Down of the transformer unit results in the problem of low voltage halogen down light turning off at random times. This is a safety feature built into the design of low voltage lighting transformers to protect the transformer against damage and, in more extreme cases, the potential of starting a fire. Thus the existing solution to the overheating of the transformer unit is to allow the internal heat to dissipate from within the transformer unit through the use of vents.

When recessed halogen down lights with remote transformers are installed, the transformer unit is placed on the base of the ceiling. As indicated previously, it is usually recommended that the transformer unit is placed a safe distance from the actual light fixture, in order to minimise the exposure of the transformer unit to the heat given off from the actual halogen down light. Furthermore, it is also recommended there is a safe height clearance between the light fixture and/or the transformer to anything above. Typically, the base of ceilings contain vast quantities of heat and noise insulation materials. These insulation materials surround the light fixture, ancillary equipment like the transformer unit and electrical wiring. The purpose of the insulation materials in the ceiling is to provide a continuous thermal barrier to minimise heat flow lost through the ceiling. Additionally, other insulation materials act as noise insulators. The Australian Standards require a 25 mm clearance between the insulation material and halogen down lights and ancillary equipment like the transformers to allow free air flow.

External heat typically builds up in the ceiling from the following sources: i) general thermal heat in the roof from the solar energy of the sun, particularly that which remains under the insulation materials; ii) hot air rising from the house into the ceiling, which is trapped under the insulation materials; iii) heat dissipated from the lights in the ceiling, which is trapped under the insulation materials; and iv) the internal heat which is dissipated by transformer units, which is trapped under the insulation material.

The insulation materials have the impact of magnifying the thermal heat generated as a result of the external heat. As with the internal heat shut down, if the build up of external heat around the transformer unit that cannot be dissipated away, that can result in the temperature of the transformer unit rising above the predetermined safety heat level causing the transformer unit to turn off (known as the “External Heat Shut Down”). As a consequence of the transformer unit turning off, the low voltage halogen light will also turn off. Furthermore, not only does this external heat impact on the proper operation of the transformer, but additionally the luminare overlamp, there are fire risks and damage can occur to the light fittings, ancillary equipment and electrical wiring.

FIG. 12 shows how insulation 90 surrounds and encases both transformer unit 91, light fitting 92 and electrical wiring 92a.

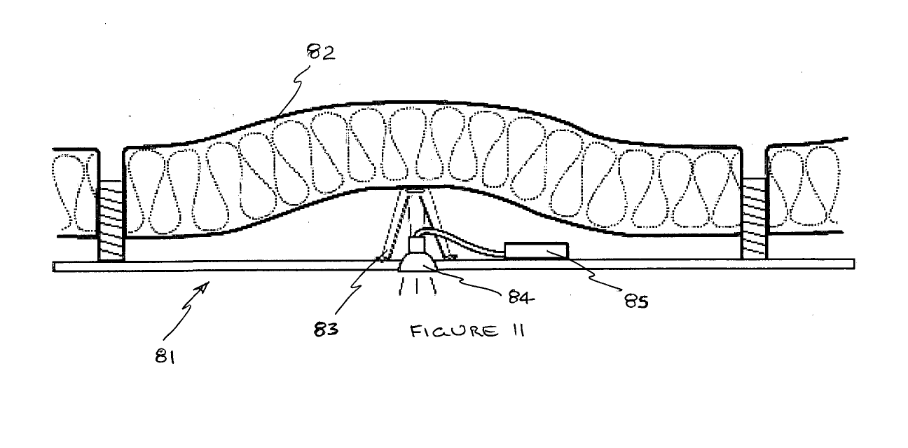

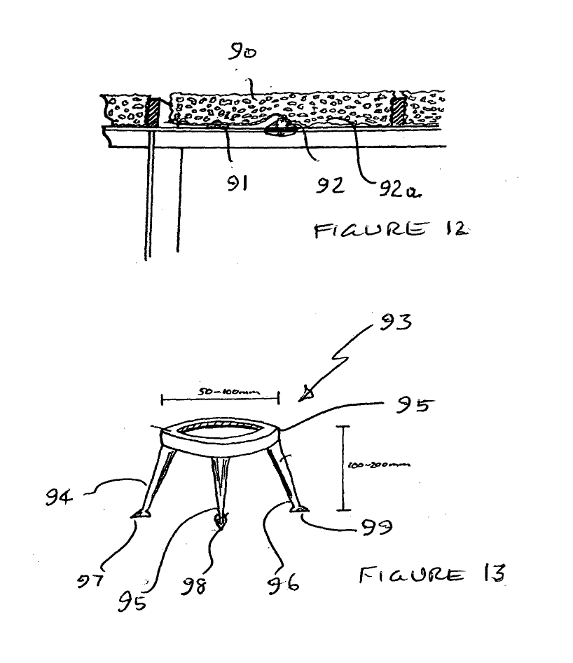

FIG. 13 shows a perspective view of a spacing device 93 according to an alternative embodiment. Device 93 includes top flat platform 95 which could be by way of example only be 50-100 mm wide and the legs 94, 95 and 96 which could be by way of example only be 100-200 mm in length. The ends of the legs have feet 97, 98 and 99 for stability in an upright position.

FIG. 14 shows a series of ventilation devices 100 located under insulation.

FIG. 15 shows a plan view of the arrangement of FIG. 14. Typically devices 100 are made preferably from a heat and fire resistant, moulded plastic. They provide a ventilation space under insulation material 101 keeps the insulation material raised from in and around the transformer unit, the light fixture, electrical equipment and ancillary equipment, allowing the thermal heat generated in these areas due to external heat to dissipate away. Device 100 also allows conformity to energy efficiency standards by not allowing either hot or cold air to escape from under the insulation materials but away from the heat sources—e.g. the light fixture and transformer unit. Furthermore, noise standards can be maintain in regards to noise insulation materials since no gaps are created between the noise insulation materials.

According to one embodiment, the legs of ventilation device 100 allow displacement and distortion enabling the capacity to adjust to tight openings. Thus the legs may be squeezed together so they can be easily inserted into the ceiling—through the hole in the ceiling in which a light fixture is placed. This is advantageous since physical access into the ceiling is thereby not required to in order to install ventilation device 100.

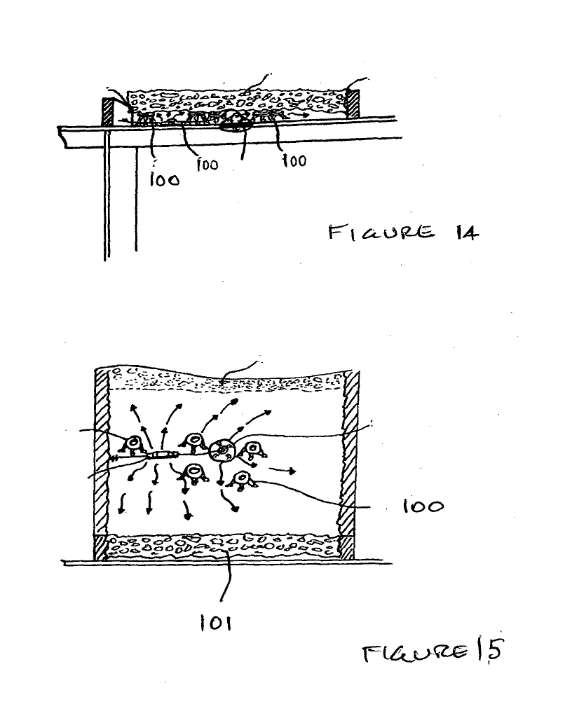

FIG. 16 shows an enlarged perspective view of a spacing device of FIG. 8 with corresponding numbering indicating scissor cutting of a frangible section 70.

FIG. 17 shows an example of insertion of the spacing device 61 of FIG. 16 displaced after cutting and manually urged through a ceiling 102 via opening 103 in the direction of arrows 104 and 108. As can be seen legs 64, 65 and 66 may be deflected to enable reduction in overall diameter of device 61 to allow insertion through opening 103.

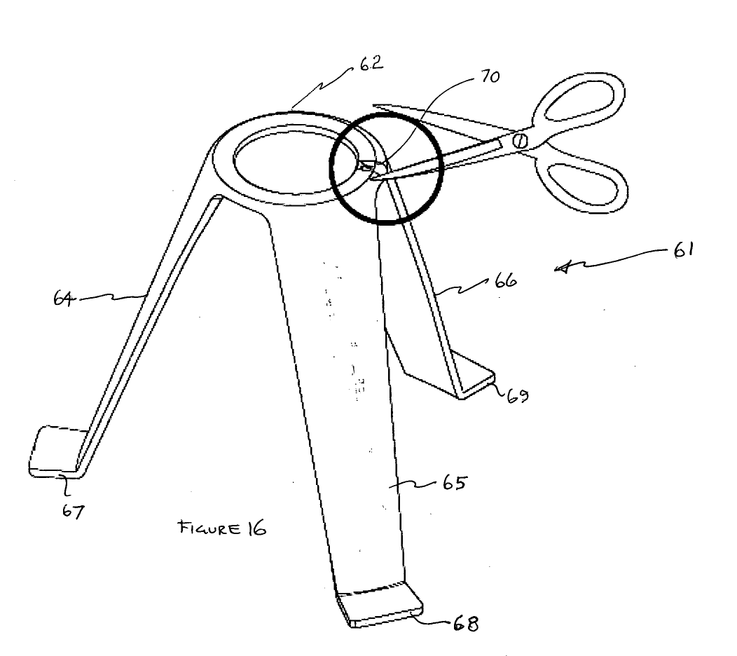

FIG. 18 shows illustratively how the sagging tendency or overhanging of the soft insulation materials 101 is reduced by the use of device 100.

FIG. 19 shows a stacked arrangement of ventilation devices 110, 111 and 112. Flat round platform 113 on device 110 not only raises the insulation material 101, but also reduces the sagging or overhanging of the soft insulation material 101 around a transformer unit or light fixture. The general splayed configuration of the ventilation devices including intermediate spaces between the legs, imparts stability under load (from insulation) and facilitates free ventilation contributing to heat dissipation. It may also be conveniently relocated with a roof space to accommodate insulation support. The height of the separation between device 100 and insulation may be adjusted by such stacking arrangement as shown in FIG. 19.

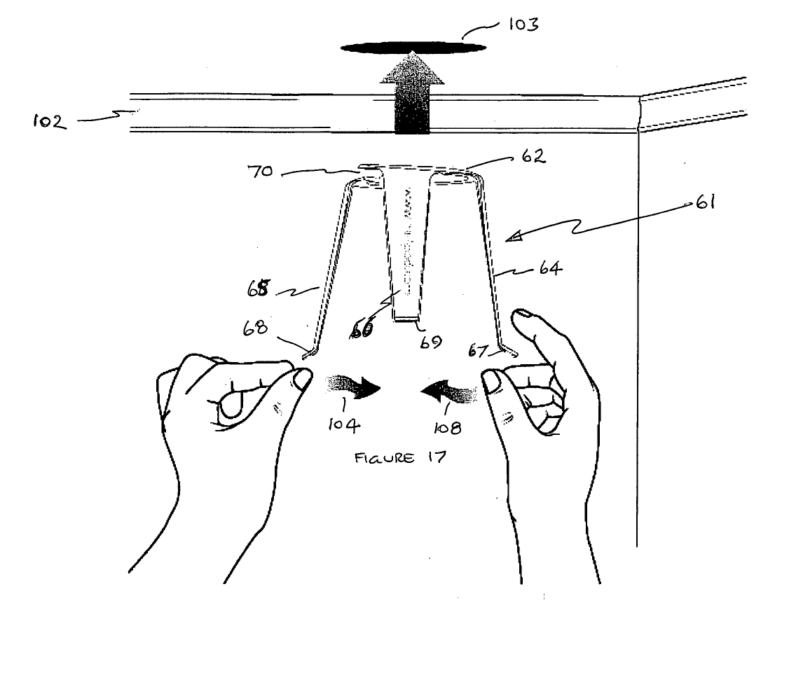

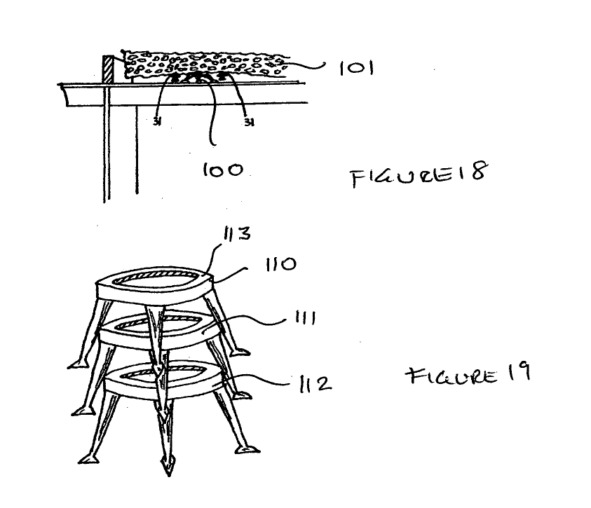

FIG. 20 shows an example of a ventilation device 120 on an inclined ceiling. This is facilitated by use of gripping means on feet of the device such as but not limited to double sided tapes. Other fasteners may be used. In some cases, a transformer unit is placed on top of the insulation material 121 but due to the soft nature of the insulation material, the transformer unit sinks into the insulation material 121, impeding heat dissipation as is shown in FIG. 21.

As shown in FIG. 22 transformer unit 122 can be fixed to platform 123 of device 124 which may then be placed directly onto the insulation material 121.

The feet of the device 120 grip into the insulation material 121 and remain stably upright. Additionally, other like devices 125 and 126 can be used under the insulation material to allow heat to dissipate from in and around the light fixture 127 as shown in FIG. 22. The arrangements described above provide a continuous thermal barrier in order to minimise heat flow lost through a ceiling, while preventing escape of hot (or cold) air from under the insulation materials.

The ventilation devices allow for the external heat to be dissipated away from the areas in and around the transformer unit and the light fixture to other areas in the ceiling, without impacting on the effectiveness of the insulation materials, the heat thereby generated spread out over a larger surface area, thus allowing the areas in and around the transformer unit and light fixture not to over heat.

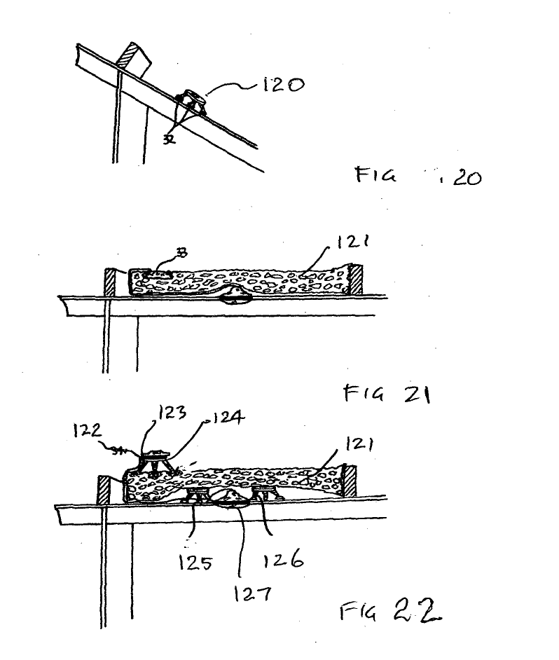

FIG. 23 shows one embodiment of a device 130 inverted in the ceiling 131 with a halogen down light 132 inserted in position via collar 141. Device 130 includes upstanding legs 133, 134, 135 and 136 each terminating in respective feet 137, 138, 139 and 140. The feet allow engagement of a like device as required in a manner similar to that described as in FIG. 3. Feet 137, 138, 139 and 140 respectively include engaging formations 141, 142, 143 and 144 to allow locking of a like member to device 130 in upright orientation to increase spacing between insulation and a ceiling.

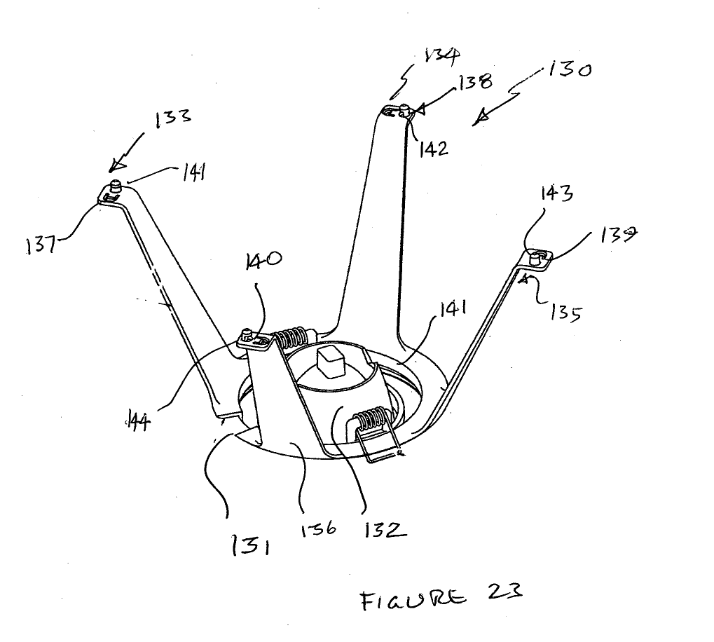

FIG. 24 shows a perspective view of a spacing device 150 according to an alternative embodiment in a contracted or furled form. FIG. 25 shows a perspective view of the device 150 of FIG. 24 unfurled. Device 150 includes openings 151 which facilitate ventilation. FIG. 26 shows an end perspective view of the device 150 of FIG. 23 in a configuration allowing insertion through a ceiling opening 152. In this embodiment the device 150 can be conveniently rolled to reduce its size to allow insertion through opening 152.

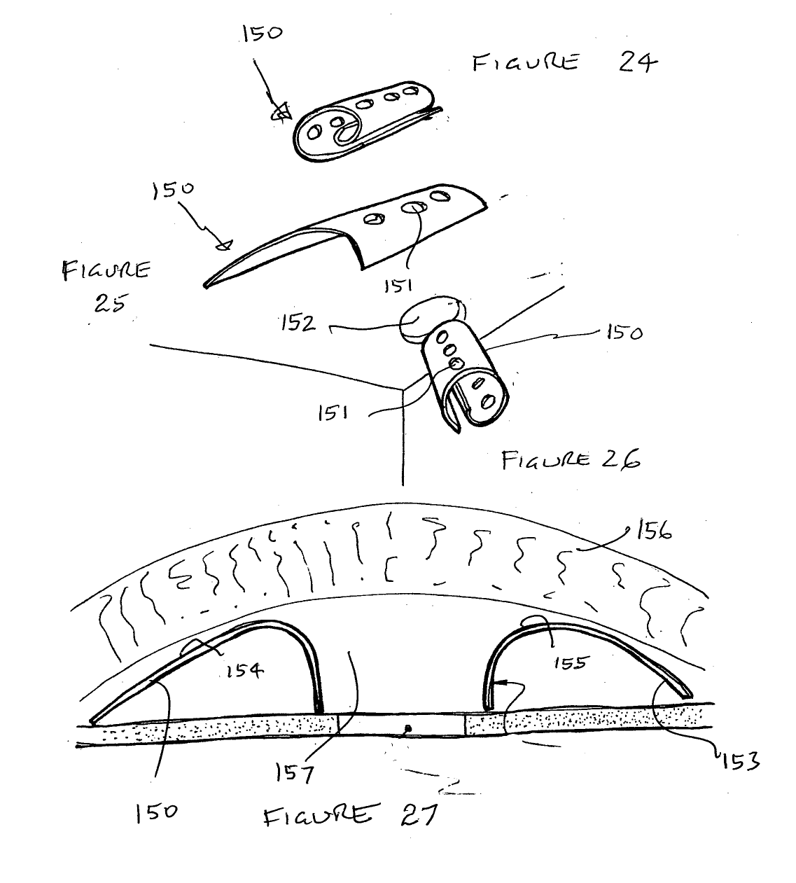

FIG. 27 shows a sectional elevation through a ceiling space with device 150 and opposing like device 153 of the type shown in FIG. 24. Devices 150 and 153 are shown unfurled with respective upper surfaces 154 and 155 supporting insulation member 156 thereby creating ventilation space 157.

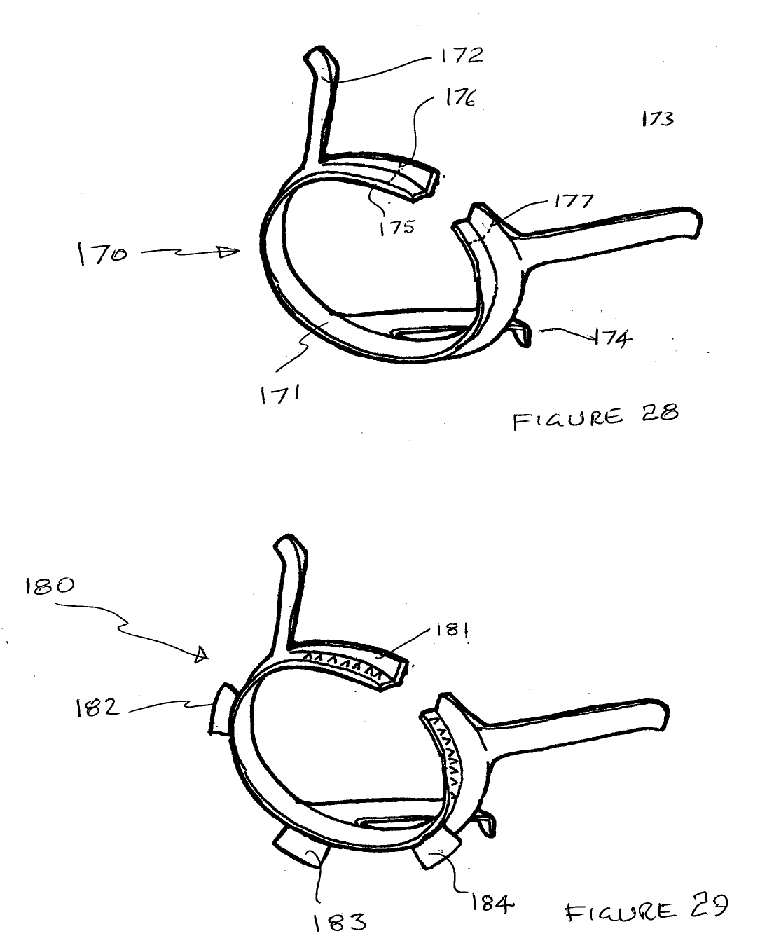

FIG. 28 shows an inverted view of a separation device 170 with split collar 171 according to an alternative embodiment. Device 170 comprises legs 172, 173 and 174 depending from split collar 171. Collar 171 also comprises flange 175 which is also split along with collar 171 to accommodate openings of different sizes in which device 170 is inserted. Collar 171 further comprises optional perforations 176 and 177 which allow further option for adjustment of the diameter of an opening (not shown) in which the device is inserted. The size of the collar on one embodiment can be changed via a perforated joints such as perforations 176 and 177 in the device 170 of FIG. 28 on the collar in order for it to fit in a range of different ceiling hole cut out sizes. A detachable collar on the underside of the ceiling will help hold the inverted device firmly in position within the ceiling hole.

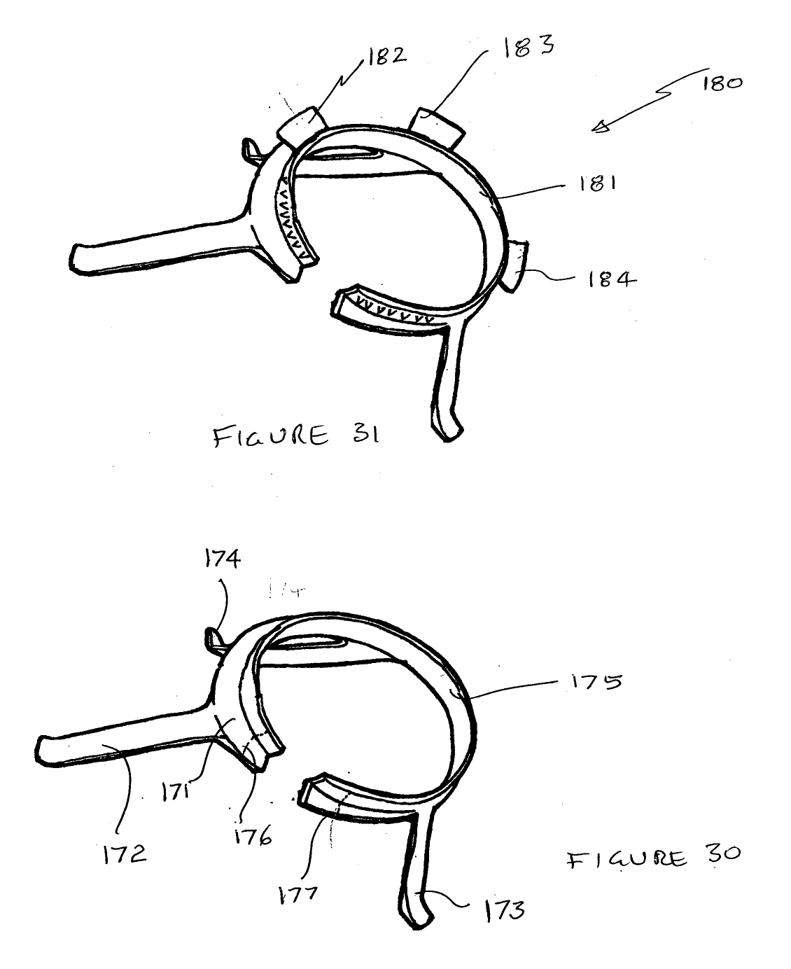

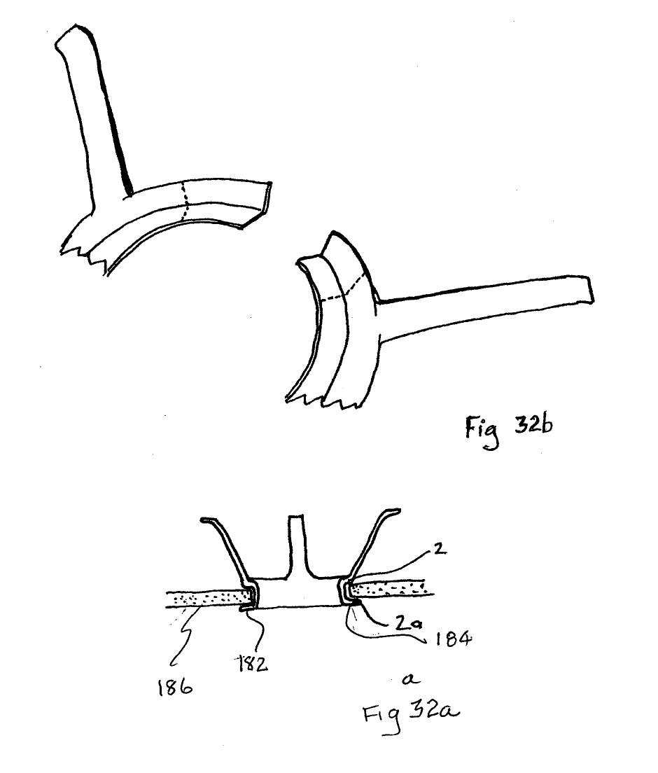

FIG. 29 shows an inverted view of a separation device 180 with split collar 181 according to an alternative embodiment. Device 180 is similar to that described with reference to FIG. 28 and includes engaging tabs 182, 183 and 184. Another collar can be added to the top of flange 171. When device 180 is inverted in the ceiling, additional collar at the top of flange 171 will fit on the underside of ceiling cladding 186 (see FIG. 32a), helping to securely hold device 1 in place. Furthermore, this collar formed as tabs 182, 183 and 184 at the top of flange 171 can have a perforated joint between the so formed collar can be removed from flange 171. FIG. 30 shows an opposite perspective view of the separation device of FIG. 28 with corresponding numbering.

FIG. 31 shows with corresponding numbering an inverted view of the separation device 180 of FIG. 29 with split collar engaging tabs 182, 183 and 184. FIG. 32a shows with corresponding numbering a cross sectional view of the separating device 180 of FIG. 29 installed in a ceiling 186 and FIG. 32b shows an abbreviated enlarged view of the device 180 of FIG. 32a showing a gap in collar 181 and perforations 189 and 190.

The present invention provides a simple, innovative and economical means of allowing low voltage recessed lighting, transformer units, other ancillary equipment and wiring within ceilings containing insulation material to dissipate sources of heat effectively, thereby minimising the chances of operation failure by the transformer, the luminare overlamping, the fire risk and/or damage to light fittings, ancillary equipment and electrical wiring. An uninterrupted coverage of insulation material (i.e. no holes or gaps in the insulation material) is maintained when using the invention, allowing for thermal and/or noise protection to be preserved. The invention also has the flexibility to be installed from below or above the ceiling. Furthermore, the invention in one form can protect ceiling hole cut out area (of multiple sizes) from potential damage when halogen down lights are removed and allows for the easy rotation for re-aiming of gimble halogen down lights. The size of the invention can be adjusted, via a perforated joint, to fit multiple ceiling hole cut out sizes when inverted.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A device which enables a ventilation space to be maintained between an insulating material and an electrical appliance retained by a structure, the device comprising:
a body having at least one spacer extending therefrom, each at least one spacer terminating in a free end:
wherein, when the device is placed between a layer of insulation material and the appliance the ventilation space is formed which allows dissipation of heat generated by the appliance.

2. A device according to claim 1 further comprising a spine from which extends said at least one spacer.

3. A device according to claim 2 wherein the spine provides a bearing surface which engages either a surface of the insulation or a surface of the structure depending upon the orientation of the device.

4. A device according to claim 3 wherein each said spacer has a first end which engages the spine and a second end which terminates in a bearing surface.

5. A device according to claim 4 wherein there are a plurality of spacers depending from the spine.

6. A device according to claim 5 wherein the spine forms an annular collar.

7. A device according to claim 6 wherein the spacers comprise legs each terminating in a foot which includes the bearing surface.

8. A device according to claim 7 wherein the plurality of spacer legs are evenly spaced about the collar.

9. A device according to claim 8 wherein the legs have 120 degree spacing therebetween.

10. A device according to claim 9 wherein the collar includes means to enable displacement of the collar so that the circumference of the collar can be reduced.

11. A device according to claim 10 wherein said displacement means comprises a frangible bridge.

12. A device according to claim 11 wherein the frangible bridge includes perforations and is removable to reduce the circumferential length of the collar.

13. A device according to claim 12 wherein reduction of the circumferential length of the collar allows insertion of the device through a variety of openings in a ceiling which are smaller than a maximum outside diameter of the collar.

14. A device according to claim 13 wherein the spacer legs and collar are integrally connected.

15. A device according to claim 14 wherein the feet each include engaging teeth on their bearing surface.

16. A device according to claim 15 wherein the structure in which the light fitting is placed is a ceiling such that the part of the light extends into a ceiling space and a light emitting part extends inside a room space.

17. A device according to claim 16 wherein the device supports an insulating element thereby keeping the insulating element separated from the appliance to enable dissipation of heat generated by the appliance.

18. A device according to claim 17 wherein the appliance comprises a light fitting or power supply cable.

19. A device according to claim 18 wherein the device is manufactured from a plastics material and formed in a mould.

20. A device according to claim 19 wherein the feet provide a support base allowing elevation of the collar above the feet.

21. A device according to claim 20 wherein the collar includes a flange which locates the device in an opening in which a light fitting is be inserted.

22. A device according to claim 21 wherein the collar provides a support base allowing elevation of the feet above the collar when the device sits in an inverted position.

23. A device according to claim 22 wherein the device is used by engaging the collar with the ceiling and allowing the legs to extend upwards.

24. A device according to claim 23 wherein the device is free standing and is placed above the light fitting in a ceiling space.

25. A device according to claim 24 wherein the device is detachably attached to a light fitting.

26. A device for maintaining a space between an insulating material and an electrical appliance located in a wall or ceiling space, the device comprising:
a body having at least one spacing leg extending therefrom, each at least one spacing leg terminating in a free end, the at least one spacing leg extending from said body and when placed adjacent or near the appliance maintains separation between an insulating material and the appliance so that the separation space so formed isolates said insulating material from said light fitting and allows ventilation of the space formed therebetween.

27. A device according to claim 27 wherein the body includes a collar from which a plurality of legs depend.

28. A device according to claim 27 wherein the collar includes a flange which is capable of seating engagement with an opening in a ceiling or wall.

29. A device according to claim 28 wherein the collar includes tabs which provide locking engagement between the spacing device and the ceiling.

30. A device which enables a ventilation space to be maintained between an insulating material and a heat emitting appliance retained by a structure, the device comprising:
a body having a formation which forms at least one spacer, each at least one spacer terminating in a free end;
wherein, when the device is placed between a layer of insulation material and the appliance the ventilation space is formed which allows dissipation of heat generated by the appliance.

31. A device according to claim 30 wherein the body is flexible and deformable.

32. A device according to claim 31 wherein the body has an elastic memory and is capable of being furled and unfurled.

33. A method of protecting a heat emitting appliance in a wall or ceiling space using a device which enables a ventilation space to be maintained between an insulating material and the appliance; the device comprising a body having at least one spacer extending therefrom, each at least one spacer terminating in a free end; the method comprising the steps of:
a) taking the device and placing it through an opening in a ceiling of a structure so that the device locates on a surface of the ceiling in a roof space;
b) placing the device between a layer of insulation material and the appliance to form a ventilation space which allows dissipation of heat generated by the appliance;
c) placing a plurality of like devices between the insulation and the appliance to create a ventilation space at the locations of each device.

34. A method according to claim 33 wherein the at least one spacers comprise a plurality of legs, each of the plurality of legs terminating in a foot which includes a bearing surface and which are evenly spaced about the collar.

35. A method according to claim 34 wherein the plurality of legs have 120 degree spacing therebetween.

36. A method according to claim 35 wherein the collar includes means to enable displacement of the collar so that the circumference of the collar can be reduced for fitting through an opening in the ceiling.

37. A method according to claim 36 wherein said displacement means comprises a frangible bridge including perforations in the collar.

38. A method according to claim 37 wherein the appliance is a light fitting mounted in or on a ceiling.

39. A method according to claim 38 wherein the appliance is electrical wiring.

40. A device which enables a ventilation space to be maintained between an insulating material and a surface of a structure, the device comprising a body having at least one spacer extending therefrom, each terminating in a free end: wherein, when the device is placed between a layer of insulation material and the surface the ventilation space is formed which allows dissipation of heat generated within the space.
